(19) United States
(12) Patent Application Publication
(10) Pub. No.: US 2013/0054882 A1
(43) Pub. Date: Feb. 28, 2013

(54) HYBRID HDD STORAGE SYSTEM AND CONTROL METHOD

(71) Applicant: JUN KIL RYU, SEONGNAM-SI (KR)

(72) Inventor: JUN KIL RYU, SEONGNAM-SI (KR)

(73) Assignee: SAMSUNG ELECTRONICS CO., LTD., SUWON-SI (KR)

(21) Appl. No.: 13/597,374

(22) Filed: Aug. 29, 2012

(30) Foreign Application Priority Data
Aug. 31, 2011 (KR) 10-2011-0087610

(51) Int. Cl. G06F 12/08; G06F 12/02

(52) U.S. Cl. 711/103; 711/113; 711/E12.008; 711/E12.019

(57) ABSTRACT

Disclosed is a storage system which includes a hard disk drive and a nonvolatile memory used as a cache device for the HDD. A connected host is used to manage a data shift between the HDD and nonvolatile memory using a virtual system memory formed by extending a system memory in the host.

### CROSS-REFERENCE TO RELATED APPLICATIONS

This application claims the benefits under 35 U.S.C. §119 of Korean Patent Application No. 10-2011-0087610 filed Aug. 31, 2011, the subject matter of which is hereby incorporated by reference.

### BACKGROUND

The inventive concept relates generally to storage systems, and more particularly, to storage systems including a Hard Disk Drive (HDD) and a nonvolatile memory device.

HDDs have been widely used as bulk data storage devices. The typical HDD accesses data (i.e., reads data from a track or stores data according to a track on a magnetic disk) by moving an arm having an attached read/write head over the magnetic disk as it spins on a rotary spindle. Thus, writing data to and reading data from the HDD necessitates one or more mechanical operations, such as moving the arm and rotating the disk. As a result of these constituent mechanical operations, the HDD is characterized by relatively high power consumption and relatively slow data access speeds.

In contrast, the so-called Solid State Disk (SSD) requires no mechanical operations, but is a storage device implemented using nonvolatile memory device(s). Many contemporary SSDs transfer data in parallel via a plurality of channels, each channel being capable of independent operation. Each channel may configured for operation with multiple memory banks, and the data throughput of the SSD may be thus increased. Because the SSD does not perform a mechanical operation like the HDD, it is comparatively characterized by relatively less power consumption, greater data access speeds and less electrical noise.

Hybrid HDD storage systems provide many of the operational and functional benefits of the HDD and SSD. In general approach, hybrid HDD storage systems use a SSD as a cache device for a HDD. The management of cache data in relation to the SSD may be managed in various methods. For example, cache data may be managed using a cache algorithm, by copying data at a high read frequency for each data block of the SSD during a defined period, and/or in relation to a particular attribute of the data being stored. By effectively managing the cache-transfer of data from the SSD to the HDD, the size and complexity of the SSD may be minimized.

### SUMMARY

One aspect of embodiments of the inventive concept is directed to provide a system comprising a storage device including a first storage device including a hard disk drive (HDD), and a second storage device including a nonvolatile memory configured as cache device for the first storage device, and a host comprising a virtual system memory, and being configured to control data access operations for the storage device using a hybrid cache management operation that manages data shifts for data stored between the first storage device and the second storage device using the virtual system memory.

Another aspect of embodiments of the inventive concept is directed to provide a storage system comprising; a hard disk drive (HDD), a nonvolatile memory (NVM) used as a cache device for the HDD, and a host configured to generate a virtual block device driver controlling operation of a HDD driver and a NVM device driver, the host using a hybrid cache data management operation as defined by the virtual block device driver.

Another aspect of embodiments of the inventive concept is directed to provide a method managing data storage in a system comprising a host and a storage device including hard disk drive (HDD) and a nonvolatile memory (NVM) used as a cache device for the HDD. The method comprises; generating a virtual block device driver in the host that controls operation of a HDD driver and a NVM device driver resident in the host, and using a hybrid cache data management operation controlled by the virtual block device driver to manage a data shift between the HDD and the NVM using a virtual system memory.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram illustrating a storage system according to an embodiment of the inventive concept.

FIG. 2 is a diagram illustrating a general software architecture for an operating method that may be used in conjunction with the storage system of FIG. 1.

FIG. 3 is a conceptual diagram describing a hybrid cache data management method for the storage system of FIG. 2.

FIG. 4 is a conceptual diagram further illustrating the second storage device of FIG. 1.

FIG. 5 is a block diagram illustrating a memory card system capable of incorporating a storage system according to an embodiment of the inventive concept.

FIG. 6 is a block diagram illustrating a solid state drive (SSD) system capable of incorporating a storage system according to an embodiment of the inventive concept.

FIG. 7 is a block diagram illustrating an electronic device capable of incorporating a storage system according to an embodiment of the inventive concept.

### DETAILED DESCRIPTION

Certain embodiments of the inventive concept will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements and features.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

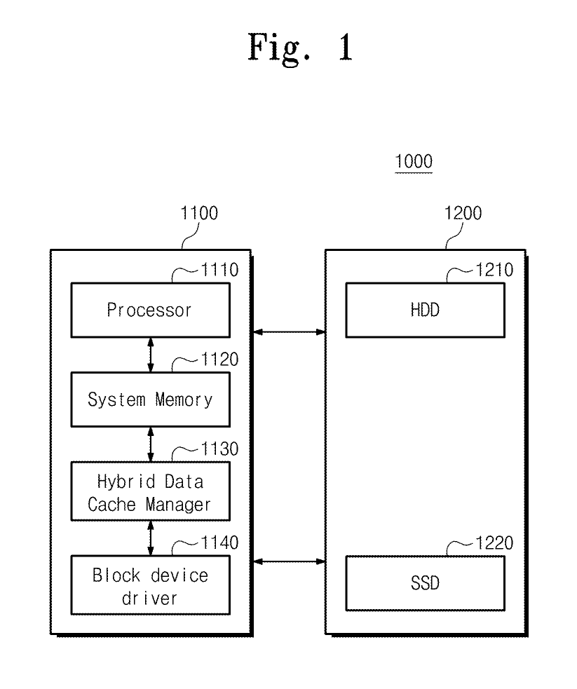

Figure (FIG.) 1 is a block diagram illustrating a storage system according to an embodiment of the inventive concept. Referring to FIG. 1, the storage system 1000 generally comprises a host 1100 and a hybrid HDD storage device 1200. Thus, the storage device 1200 comprises a first storage device 1210 and a second storage device 1220. In the illustrated embodiment, the first storage device 1210 is a Hard Disk Drive (HDD) and the second storage device 1220 is a Solid State Disk (SSD). Alternately, the second storage device 1220 might be implemented using other arrangements of nonvolatile memory-based storage devices, such as a memory card, a USB memory, etc.

The host 1100 may communicate with the storage device 1200 using USB (Universal Serial Bus), SCSI (Small Computer System Interface), PCI express, ATA, PATA (Parallel ATA), SATA (Serial ATA), SAS (Serial Attached SCSI), etc. In certain embodiments, one interface for the storage device 1200 may perform a disk emulation function which enables the host 1100 to essentially recognize for purposes of data transfer the second storage device 1200 as the HDD.

The host 1100 illustrated in FIG. 1 comprises a processor 1110, a system memory 1120, a hybrid data cache manager 1130, and a block device driver 1140. The processor 1110 may implemented with any type of processing unit or controller capable of controlling the overall operation of the storage system 1000. The system memory 1120 may be used as a main memory for the host 1100, and may be implemented using Dynamic random Access Memory (DRAM) and/or Synchronous Random Access Memory (SRAM).

The system memory 1120 operates under the control of the processor 1110, and may be used as one or more of a working memory, buffer memory, cache memory, etc. Further, the system memory 1120 may be used as a drive memory in conjunction with the operation of the first and second storage devices 1210 and 1220.

In a case where the system memory 1120 is used as a work memory, data processed by the processor 1110 may be temporarily stored in the system memory 1120. If the system memory 1120 is used as a buffer memory, it may be used to buffer data being transferred between the storage device 1200 and host 1100. As a cache memory, the system memory 1120 may enable operation of the low-speed storage device 1200 to operate at relatively higher speed. In the event that the system memory 1120 is used as a drive memory, it may be used in conjunction with the block device driver 1140.

The hybrid data cache manager 1130 may be used to manage a first device driver (not shown) controlling the first storage device 1210 (HDD) and a second device driver (not shown) controlling the second storage device 1220 SSD).

The block device driver 1140 may be commonly used to drive the first and second storage devices 1210 and 1220. As described above, the block device driver 1140 may operate in conjunction with the system memory 1120 under the control of the hybrid data cache manager 1130.

Upon initialization (or “booting”) of the storage system 1000 including the first storage device (HDD) 1210, the requisite “boot time” required to load data to the system memory 1120 may be unacceptably long. Further, the first storage device 1210 may only stably receive or transfer data once the rotational speed of the magnetic disk reaches a given level (e.g., 6000 rpm). Accordingly, the first storage device 1210 may necessitate a considerable period of time before data may be accessed (read and/or written) to the constituent magnetic disk. Further, the first storage device 1210 consumes a great quantity of power while performing the necessary mechanical operations such as arm shifting and disk rotation.

To compensate for the above-described drawbacks of the first storage device 1210, the storage system 1000 of FIG. 1 uses the first storage device 1210 as a main storage device while effectively using the second storage device (SSD) 1220 as a cache device. In FIG. 1, the second storage device 1220 is assumed to be a SSD, but those skilled in the art will recognize that the second storage device 1220 might alternately be implemented using other configurations of nonvolatile memory, such as a flash memory, a Phase-change RAM (PRAM), etc. For example, in certain embodiments of the inventive concept, the second storage device 1220 may include a NAND flash memory-based memory card, a NAND flash memory-based USB memory, etc.

In contrast to the first storage device 1210, the boot time and/or the read time for the second storage device 1220 is relatively short. Further, data access operations for the second storage device 1220 do not necessitate one or more mechanical operation(s), power consumption is considerably less.

Further, in the event that the system memory 1120 for the host 1100 is used as a “host cache memory”, the second storage device 1220 may be used as a “first storage device (or HDD) cache memory”. Thus, the storage system 1000 of FIG. 1 according to an embodiment of the inventive concept may include two (2) independent (but interoperable) cache memories; the system memory 1120 and the second storage device 1220.

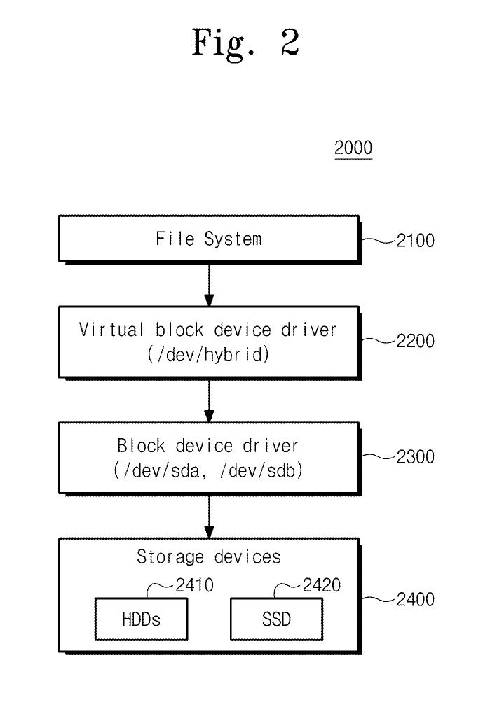

FIG. 2 is a diagram illustrating a software architecture further describing an operating method for the storage system of FIG. 1. Referring to FIG. 2, the software architecture (or storage system software arrangement) 2000 includes a file system 2100, a virtual block device driver 2200, a block device driver 2300, and storage devices 2400. With additional reference to FIG. 1, the software components operating in conjunction with the storage devices 2400 may include a first storage device components (HDD) 2410 and a second storage device components (SSD) 2420. In this context, the first storage device 2410 is assumed to be used as a main storage device, and the second storage device 2420 is assumed to be used as a cache device for the first storage device 2410.

The storage system software 2000 may be configured to manage cache data using the virtual block device driver 2200 (/dev/hybrid) and/or oen or more block device driver(s) 2300. In the illustrated embodiment of FIG. 2, the block device driver(s) 2300 includes a first device driver (/dev/sda) associated with (i.e., the first storage device 2410 and a second device driver (/dev/sdb) associated with the second storage device 2420.

The file system 2100 is assumed to run on the virtual block device driver 2100, and may include (e.g.,) such conventionally understood components as Ext3/4, ReiserFS, NTFS, etc.

In case of the storage system software 2000 of FIG. 2, a system program may be divided into the first and second device drivers /dev/sda and /dev/sdb, or there may be no need to process hot data and cold data. Alternately, certain embodiments of the inventive concept may automatically direct hot data to the second device driver (/dev/sdb) using a hybrid cache data management technique within (e.g.,) the virtual block device driver 2200.

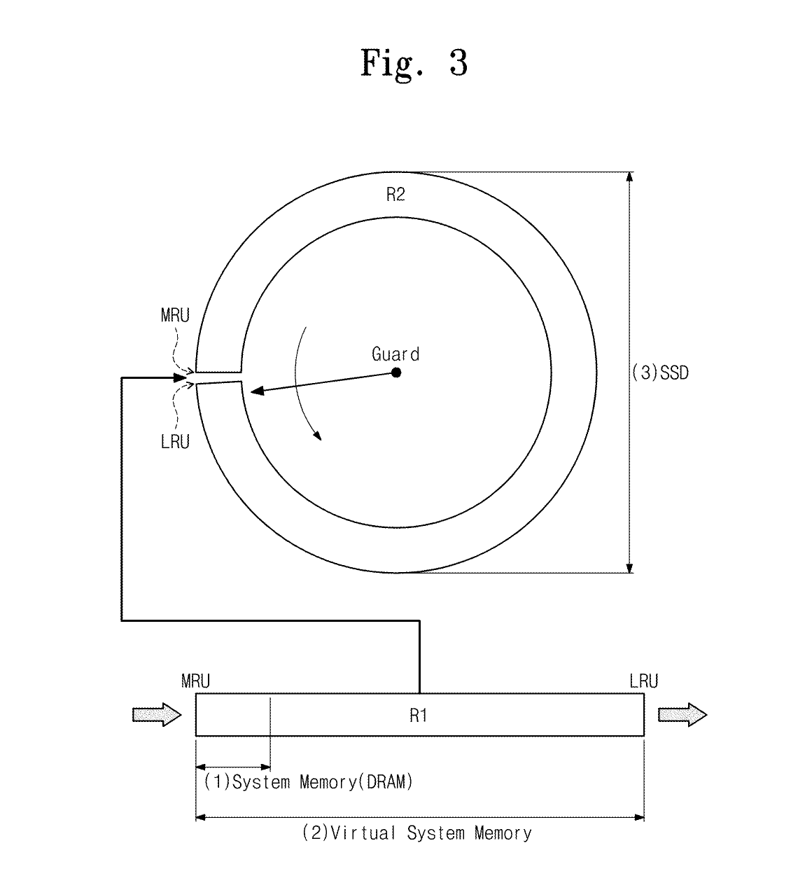

FIG. 3 is a conceptual diagram further illustrating a hybrid cache data managing method for the storage system of FIGS. 1 and 2.

In FIG. 3, the system memory 1120 is high-speed cache memory (e.g., DRAM) mounted on a mother board of the storage system 1000. A virtual system memory may be used to analyze workload pattern(s) for data being communicated by the storage system 1000, and may be formed by extending the system memory 1120 virtually. Access pattern information for data associated with the first storage device (HDD) 1210 (e.g., read-request start address(es), size(s) for requested data, etc.) may be recorded as a “first access pattern information list” at an arbitrary location “R1” of the virtual system memory. Accordingly, embodiments of the inventive concept do not necessarily require large amounts of memory space to implement the virtual system memory.

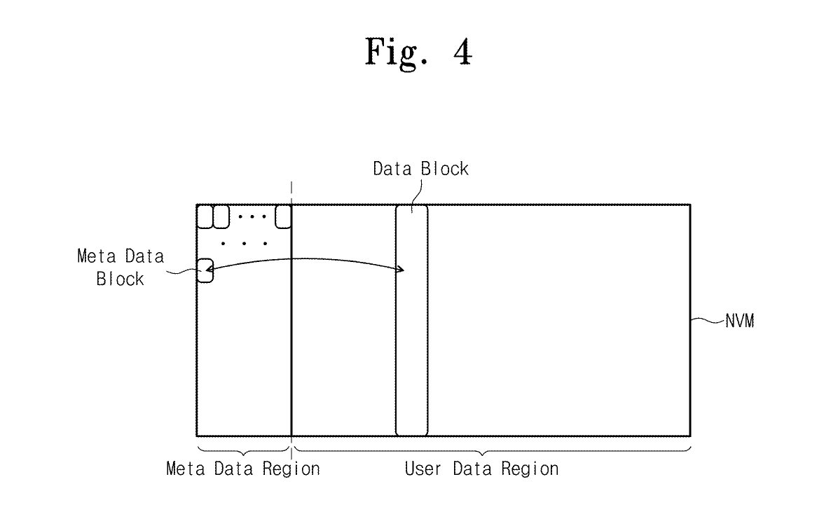

The first access pattern information list may be managed by the system memory 1120. In contrast, a “second access pattern information list” associated with the second storage device (SSD) 1220 may be stored at location “R2”. here again, the configuration of the second access pattern information list may be made on the system memory 1120. Possible data configuration for the second storage device (SSD) 1220 will be more fully described with reference to FIG. 4.

Data read from the second storage device 1220 may be stored using the virtual system memory. If a reference count for accessed data exceeds a threshold, it may be moved to a Most Recently Used (MRU) portion of the virtual memory system. This may mean that data is stored in the second storage device 1220.

If the reference count remains less than a defined threshold, hot read data may be stored in the second storage device 1220. If the threshold is relatively high, frequently read data having a given pattern may be stored in the second storage device 1220. Accordingly, as the threshold is raised, more frequently read data may be shifted. Accordingly, an operating performance of the second storage device 1220 may be improved.

If there is no available space in the second storage device 1220, a victim block from among an existing plurality of data blocks may be selected using the second access pattern information list. The victim block may be selected using a variety of factors and considerations. For example, a data block having a reference count of 0 may be selected from a Least Recently Used (LRU) portion of the virtual memory system.

Continuing with FIG. 3, when a victim block is selected using the second access pattern information list, an established data guard (e.g., a defining data type boundary) may move from the MRU portion of the virtual system memory towards the LRU portion to confirm a reference count. If the reference count exceeds 0, a next data block may be checked counterclockwise. Prior to moving to a next data block, a reference count of a data block, which is not selected as a victim block, may decrease by one. If a data block of the R2 list responds to an I/O request, a location of the data block may be shifted into an MRU location, and a reference count may increase by one.

FIG. 4 is a conceptual diagram further illustrating the second storage device of FIG. 1. Referring to FIG. 4, the second storage device (SSD) 1220 may be divided into a metadata region and a user data region. Metadata may be grouped to be stored in one metadata block. A size of a data block may be defined to be larger (e.g., 32 KB) than that of a sector of a first storage device 1210, considering a size of a system memory 1120, which is to be used to manage each data block, and performance and endurance characteristics of a nonvolatile memory.

Thus, a system according to embodiments of the inventive concept and comprising a storage device and connected host may use a hybrid cache management method that is essentially capable of adjusting a data read frequency by varying the storage assignment for incoming data as between a HDD and SSD of the storage device using a virtual system memory.

A storage system according to embodiments of the inventive concept may be incorporated into various products, such as electronic devices including personal computers, digital cameras, camcorders, handheld phones, MP3 players, PMPs, PSPs, PDAs, etc.

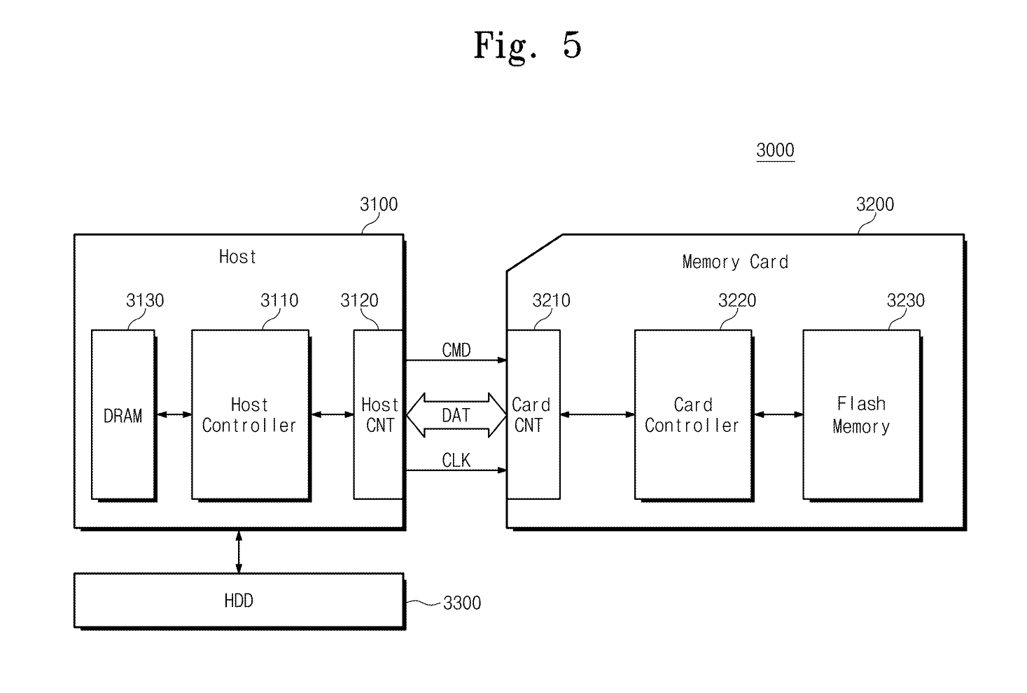

FIG. 5 is a block diagram illustrating a memory card system incorporating a storage system according to an embodiment of the inventive concept. A memory card system 3000 comprises a host 3100, a memory card 3200, and a hard disk drive (HDD) 3300. The host 3100 may include a host controller 3110, a host connection unit 3120, and a DRAM 3130.

The host 3100 may write data in the memory card 3200 and read data from the memory card 3200. The host controller 3110 may send a command (e.g., a write command), a clock signal CLK generated from a clock generator (not shown) in the host 3100, and data to the memory card 3200 via the host connection unit 3120. The DRAM 3130 may be a main memory of the host 3100.

The memory card 3200 may include a card connection unit 3210, a card controller 3220, and a flash memory 3230. The card controller 3220 may store data in the flash memory 3230 in response to a command input via the card connection unit 3210. The data may be stored in synchronization with a clock signal generated from a clock generator (not shown) in the card controller 3220. The flash memory 3230 may store data transferred from the host 3100. For example, in a case where the host 3100 is a digital camera, the flash memory 3230 may store image data.

The hard disk driver 3300 may be an embedded HDD included in the host 3100 or an external HDD connected with the host 3100. The memory card system 3000 according to the inventive concept may be a hybrid storage system which uses the first storage device (HDD) 3300 as a main storage device and the second storage device (a memory card) 3300 as a cache device.

As described above, embodiments of the inventive concept may use a hybrid cache management method that is capable of adjusting a data read frequency, which is used to decide a shift into a second storage device (memory card) using a virtual system memory, and a reception adaptable to a workload pattern variation level via a threshold.

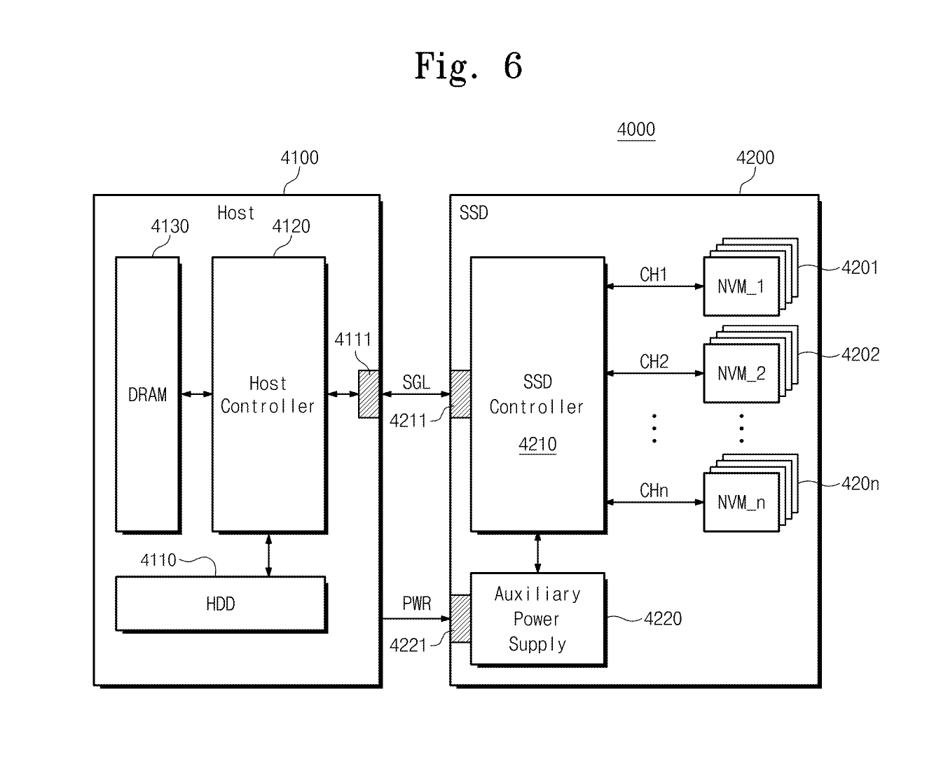

FIG. 6 is a block diagram illustrating a solid state drive system including a storage system according to an embodiment of the inventive concept. Referring to FIG. 6, a solid state drive (SSD) system 4000 comprises a host 4100 and an SSD 4200. The host 4100 may include a host interface 4111, a hard disk drive (HDD) 4110, a host controller 4120, and a DRAM 4130. Herein, the HDD 4110 can be externally or internally disposed relative to the host 4100.

The host 4100 may write data in the HDD 4110 or the SSD 4200 or read data from the HDD 4110 or the SSD 4200. The host controller 4120 may transfer signals SGL such as a command, an address, a control signal, etc. to the SSD 4200 via the host interface 4111. The DRAM 4130 may be a main memory of the host 4100.

The SSD 4200 may exchange signals SGL with the host 4100 via the host interface 4211 and may be supplied with a power via a power connector 4221. The SSD 4200 may include a plurality of nonvolatile memories 4201 to 420n, an SSD controller 4210, and an auxiliary power supply 4220. Herein, the nonvolatile memories 4201 to 420n may be implemented using (e.g.,) flash memory, PRAM, MRAM, ReRAM, etc.

The plurality of nonvolatile memories 4201 to 420n may be used as a storage medium of the SSD 4200. The plurality of nonvolatile memories 4201 to 420n may be connected with the SSD controller 4210 via a plurality of channels CH1 to CHn. One channel may be connected with one or more nonvolatile memories. Nonvolatile memories connected with one channel may be connected with the same data bus.

The SSD controller 4210 may exchange signals SGL with the host 4100 via the host interface 4211. Herein, the signals SGL may include a command, an address, data, and the like. The SSD controller 4210 may be configured to write or read out data to or from a corresponding nonvolatile memory according to a command of the host 4100.

The auxiliary power supply 4220 may be connected with the host 4100 via the power connector 4221. The auxiliary power supply 4220 may be charged by a power PWR from the host 4100. The auxiliary power supply 4220 may be placed within the SSD 4200 or outside the SSD 4200. For example, the auxiliary power supply 4220 may be put on a main board to supply an auxiliary power to the SSD 4200.

The SSD system 4000 according to the inventive concept may be a hybrid storage system which uses the first storage device (HDD) 4110 as a main storage device and the second storage device (SSD) 4200 as a cache device.

The inventive concept may use a hybrid cache management method which is capable of adjusting a data read frequency, which is used to decide a shift into a second storage device SSD using a virtual system memory, and a reception adaptable to a workload pattern variation level via a threshold.

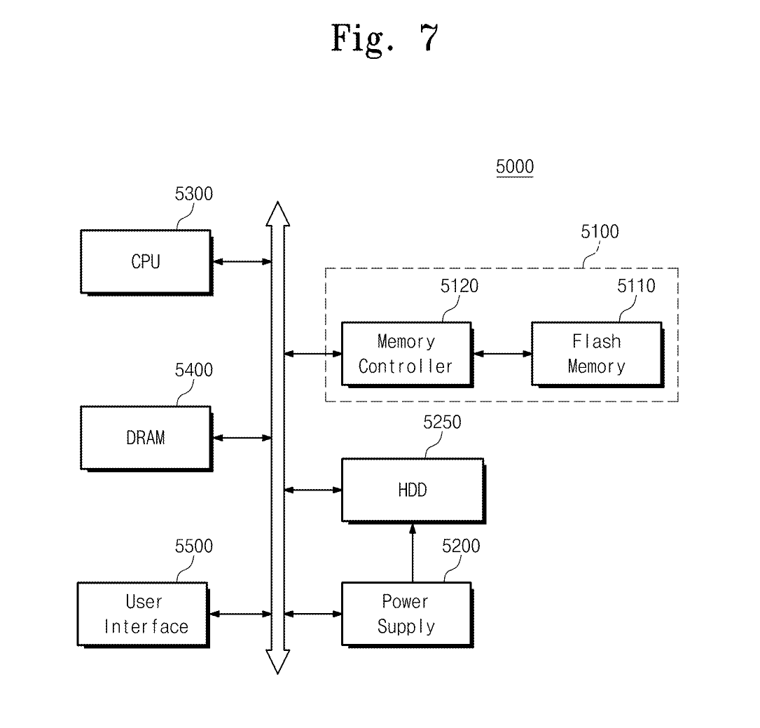

FIG. 7 is a block diagram illustrating an electronic device incorporating a storage system according to an embodiment of the inventive concept. Herein, an electronic device 5000 may be a personal computer or a handheld electronic device such as a notebook computer, a cellular phone, a PDA, a camera, etc.

Referring to FIG. 7, the electronic device 5000 comprises a memory system 5100, a power supply device 5200, a hard disk driver 5250, a CPU 5300, a DRAM 5400, and a user interface 5500. The memory system 5100 may include a flash memory 5110 and a memory controller 5120.

The electronic device 5000 according to the inventive concept may be a hybrid storage system which uses the first storage device (HDD) 5250 as a main storage device and the second storage device (a memory system) 5100 as a cache device.

The above-disclosed subject matter is to be considered illustrative, and not restrictive, and the appended claims are intended to cover all modifications, enhancements, and other embodiments that fall within the scope of the inventive concept as defined by the attaché claims. Thus, to the maximum extent allowed by law, the scope is to be determined by the broadest permissible interpretation of the following claims and their equivalents, and shall not be restricted or limited by the foregoing detailed description.

What is claimed is:

1. A system comprising:
a storage device including a first storage device including a hard disk drive (HDD), and a second storage device including a nonvolatile memory configured as cache device for the first storage device; and
a host comprising a virtual system memory, and being configured to control data access operations for the storage device using a hybrid cache management operation that manages data shifts for data stored between the first storage device and the second storage device using the virtual system memory.

2. The storage system of claim 1, wherein the host further comprises:
a hybrid data cache manager controlling the hybrid cache management operation and configured to manage the data shifts according to a defined data read frequency and at least one access pattern information list.

3. The storage system of claim 2, wherein the hybrid data cache manager manages the data shifts according to a reference count and a corresponding threshold.

4. The storage system of claim 3, wherein the threshold is variable.

5. The storage system of claim 1, wherein the host further comprises a virtual block device driver including a first device driver for the first storage device and second device driver for the second storage device.

6. The storage system of claim 1, wherein the nonvolatile memory is a flash memory.

7. The storage system of claim 1, wherein the second storage device is a memory card.

8. The storage system of claim 1, wherein the second storage device is a solid state disk (SSD).

9. The storage system of claim 1, wherein the second storage device is a memory system including a flash memory.

10. The storage system of claim 1, wherein the host is further configured to store an access pattern information list for the virtual memory system upon reading of data stored by the first storage device.

11. The storage system of claim 1, wherein if no available space exists in the second storage device for incoming data, a victim block is selected from among a plurality of data blocks.

12. A storage system comprising:
a hard disk drive (HDD);
a nonvolatile memory (NVM) used as a cache device for the HDD; and
a host configured to generate a virtual block device driver controlling operation of a HDD driver and a NVM device driver, the host using a hybrid cache data management operation as defined by the virtual block device driver.

13. The storage system of claim 12, wherein the host automatically stores hot data to the NVM using the NVM device driver during the hybrid cache data management operation.

14. The storage system of claim 12, wherein the host includes a virtual system memory formed by extending a system memory, and the host is configured to manage a data shift between the HDD and the NVM using the virtual system memory.

15. The storage system of claim 14, wherein the virtual system memory analyzes a data access pattern for at least one of the HDD and the NVM.

16. A method managing data storage in a system comprising a host and a storage device including hard disk drive (HDD) and a nonvolatile memory (NVM) used as a cache device for the HDD, the method comprising:
generating a virtual block device driver in the host that controls operation of a HDD driver and a NVM device driver resident in the host; and
using a hybrid cache data management operation controlled by the virtual block device driver to manage a data shift between the HDD and the NVM using a virtual system memory.

17. The method of claim 16, further comprising:
using the hybrid cache data management operation to automatically store incoming data identified as hot data to the NVM using the NVM device driver.

18. The method of claim 16, further comprising:
virtually extending a system memory resident in the host to form the virtual system memory.

19. The method of claim 18, further comprising:
analyzing a data access pattern for at least one of the HDD and the NVM to virtually extend the system memory.

20. The method of claim 19, further comprising:
forming an access pattern information list in response to analyzing the data access pattern and storing the access pattern information list in the NVM.
